(19) United States
(12) Patent Application Publication
(10) Pub. No.: US 2001/0003017 A1
(43) Pub. Date: Jun. 7, 2001

(54) Electronic equipment, method of manufacturing a casing for electronic equipment and punching apparatus

(76) Inventors: Takashi Hosoi, Tokyo (JP); Nobuyuki Takaki, Tokyo (JP); Yasuo Ono, Yokohama-shi (JP); Mikio Kiuchi, Kawagoe-shi (JP)

Correspondence Address: Finnegan, Henderson, Farabow, Garrett & Dunner, L.L.P., 1300 I Street, N.W., Washington, DC, 20005-3315, US

(21) Appl. No.: 09/740,875

(22) Filed: Dec. 21, 2000

Related U.S. Application Data
(63) Continuation of application No. PCT/JP99/03237, filed on Jun. 17, 1999.

(30) Foreign Application Priority Data
Jun. 22, 1998 (JP) 10-174977

(51) Int. Cl. B32B 1/02; B29C 45/17; B22D 31/00; B26F 1/14

(52) U.S. Cl. 428/34.1; 264/155; 164/69.1; 83/686; 83/690

(57) ABSTRACT

Disclosed is a method of manufacturing a casing for an electronic equipment, the casing having a rib of a predetermined height and an insertion hole formed inside the rib in the width direction. The manufacturing method comprises the steps of preparing a molded article having a rib of a predetermined height and a concave portion positioned inside the rib in the width direction, the concave portion having a bottom wall portion, allowing a concave portion supporting die having a punch insertion hole formed therein to be engaged with the bottom portion so as to fix the molded article, and moving a punch from a side opposite to the bottom portion of the molded article engaged with the concave portion supporting die so as to punch the bottom portion positioned inside a punch insertion hole and, thus, to form an insertion hole.

### CROSS REFERENCE TO RELATED APPLICATIONS

This is a Continuation of Application No. PCT/JP99/03237, filed Jun. 17, 1999.

This application is based upon and claims the benefit of priority from the prior Japanese Patent Application No. 10-174977, filed Jun. 22, 1998, the entire contents of which are incorporated herein by reference.

### BACKGROUND OF THE INVENTION

The present invention relates to the construction of a casing for an electronic equipment and a method of manufacturing the casing, particularly, to a casing for an electronic equipment having a hole section inside a rib.

In recent years, a magnesium alloy is used mainly as a material of a casing for an electronic equipment made of a light metal. The alloy is molded by a die casting method or a thixotropic method for forming the casing. These molding methods differ from each other in conditions depending on the construction of the apparatus to be molded. In any of these molding methods, however, an alloy melted and heated to 580° C. to 750° C. is injected into the mold cavity heated to about 100° C. to 350° C.

FIG. 1 shows the construction of a conventional casing for an electronic equipment. In molding the casing for an electronic equipment, a molten metal is introduced from a sprue 2 of a molding apparatus 1 and, then, passes through a runner 3 so as to be introduced into the inner space of the molding apparatus 1. The drawing shows the shape of the casing for an electronic equipment immediately after the molding. In the following description, each portion of the molding apparatus 1 is described in conjunction with the portion corresponding to the shape of the casing for an electronic equipment immediately after the molding. The molten metal introduced into the inner space of the molding apparatus 1 flows over the entire region of a cavity 4 so as to reach finally an air vent 5. Further, a basin 6 is joined to the air vent 5. Therefore, if a molten metal is introduced from the sprue 2, the air is released to the outside through the air vent 5. As a result, it is possible to carry out the molding in a manner to prevent the void from being present inside the casing.

FIG. 1 shows the shape of the casing immediately after the molding. In order to use the casing of the shape immediately after the molding as a casing for an electronic equipment, it is necessary to cut away the sprue 2, the runner 3, the air vent 5 and the basin 6.

In the conventional casing for an electronic equipment, a rib 7 is formed and an insertion hole 8 is formed inside the rib 7. In order to form the insertion hole 8 inside the rib 7 in its width direction, a hole portion is formed in an upper mold for forming the cavity 4, and a projecting portion from the hole portion is formed. As a result, it is possible to mold integrally a casing for an electronic equipment having the insertion hole 8 inside the rib 7 in its width direction by an injection molding.

However, if the projecting portion is formed to close the inner space of the cavity 4, it is impossible to ensure a passageway of the melt so as to impair the flowability. In order to promote the flowability of the melt without impairing the flowability within the cavity 4, the projecting length of the projecting portion is limited such that the projecting edge of the projecting portion is not in contact with the cavity 4 on the other side so as to form a predetermined clearance therebetween. As a result, the melt is loaded in the cavity 4 so as to ensure a desired thickness of the casing for an electronic equipment.

In the molded article formed by the injection molding, the insertion hole does not extend through the portion corresponding to the insertion hole 8 and, thus, the insertion hole 8 is closed. Then, the insertion hole 8 is formed inside the rib 7 by applying a mechanical processing such as drilling to the closed bottom portion of the insertion hole 8.

The conventional method of applying an after-treatment such as a mechanical processing using, for example, a drill to the bottom portion necessitates a longer processing time, compared with the punching process such as pressing, leading to an increased manufacturing cost.

It is conceivable to apply punching such as press working to the bottom portion inward the rib 7 in the width direction. However, it is difficult to have the bottom portion clipped by dies and strippers because of the presence of a projecting structure of the rib.

If the punching process is performed in the press working step by using a punching apparatus 10 shown in FIG. 2, a clearance formed between the edge portion of the molded article 11 fixed to a die 12 and the punching edge of the punch 13 causes the molded article 11 to be elastically deformed, resulting in failure to form a good cross sectional area in the punching process step.

What should also be noted is that, if the punching process is performed with the projecting edge of the rib 7 fixed or with the root portion on the outside of the rib 7 fixed as shown in FIG. 2, a problem is generated because the punching portion is positioned apart from the edge portion fixed by the die 12. Specifically, the rib 7 tends to be bent by the stress concentration about the fixed edge portion.

### BRIEF SUMMARY OF THE INVENTION

An object of the present invention, which has been achieved in view of the situation described above, is to provide an electronic equipment having a casing in which a good insertion hole can be formed by even a punching process in the case of forming the insertion hole within a rib, a method of manufacturing a casing for an electronic equipment, and a punching apparatus.

According to a first aspect of the present invention, there is provided a method of manufacturing a casing for an electronic equipment, comprising the steps of:

preparing a molded article in which is formed a wall portion surrounded by a rib having a predetermined height;

allowing a supporting means formed to conform with the wall portion surrounded by the rib and having a hollow portion to be engaged with the wall portion so as to fix the molded article; and

punching that portion of the wall portion which is positioned inside the hollow portion by punching means from a side opposite to the side of the supporting means with the wall portion interposed therebetween so as to form a through-hole.

According to a second aspect of the present invention, there is provided an electronic equipment comprising a casing having a hub of a predetermined height projecting from a wall portion and a hole formed inside the hub in a manner to extend through the wall portion, wherein a punching residue projecting inward in the circumferential direction of the hole is formed on the edge portion on the side of the wall portion of the hole.

Further, according to a third aspect of the present invention, there is provided a punching apparatus having supporting means, the punching apparatus being used in the case where a wall portion formed inside a rib of a molded article is punched for forming a hole positioned inside a rib of a casing for an electronic equipment, wherein the supporting means is shaped to conform with the concave portion inside the rib and has a hole portion through which punching means can be inserted inward.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is an oblique view showing the shape of a conventional casing for an electronic equipment;

FIG. 2 is a cross sectional view showing the construction of a conventional punching apparatus;

FIG. 3 is an oblique view showing the construction of a portable computer as an electronic equipment according to one embodiment of the present invention;

FIG. 4 is an oblique view showing the shape of the casing for an electronic equipment according to one embodiment of the present invention;

FIG. 5 is a cross sectional view showing the construction of a punching apparatus according to one embodiment of the present invention; and

FIG. 6 is a cross sectional view showing the shape of a molding apparatus according to one embodiment of the present invention.

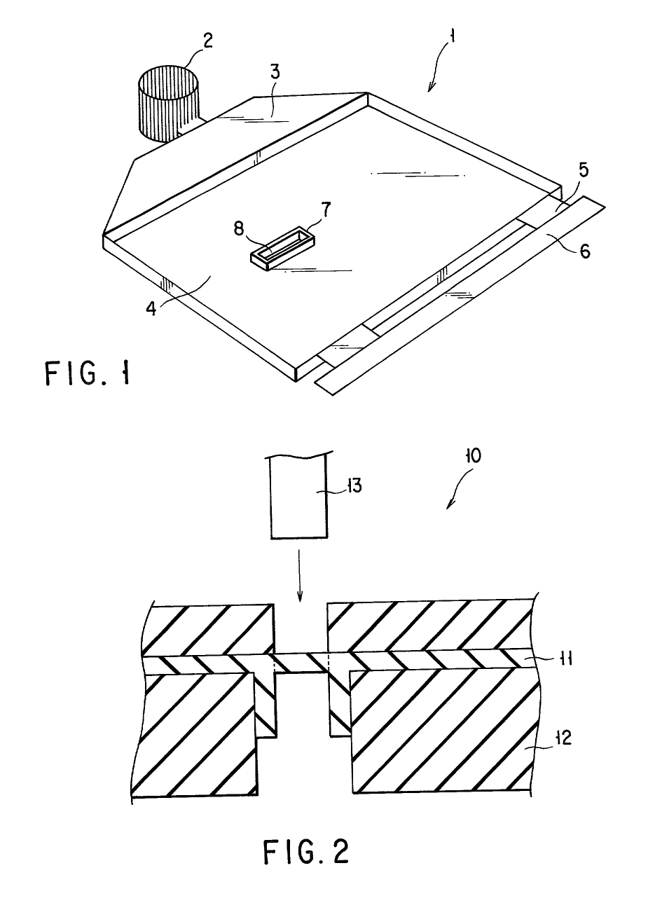

### DETAILED DESCRIPTION OF THE INVENTION

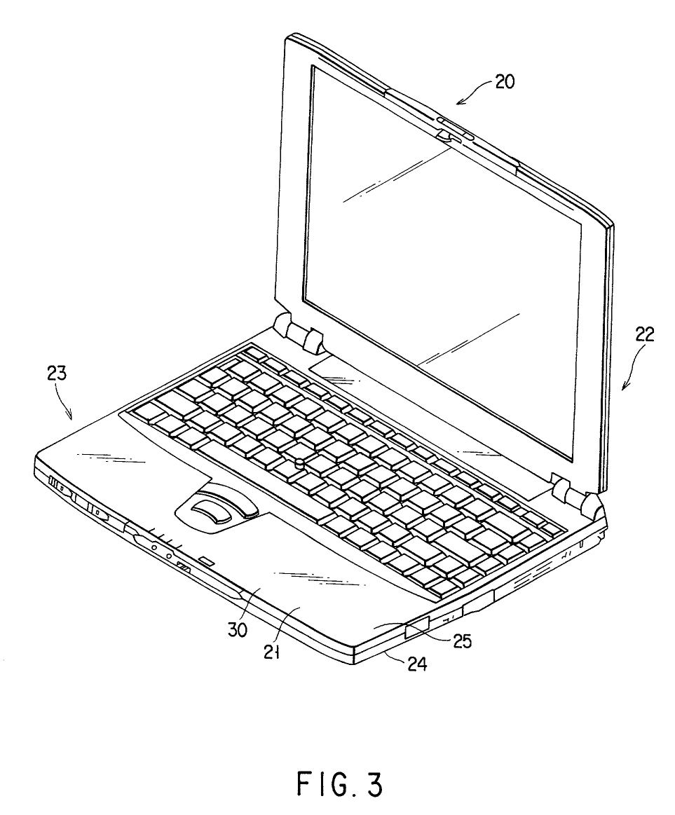

One embodiment of the present invention will now be described with reference to FIGS. 3 to 6.

FIG. 3 shows an outer appearance of a portable computer 20 such as a notebook type personal computer. As shown in the drawing, the portable computer 20 comprises a computer body 21 and a display unit 22 swingably supported by the computer body 21. The computer body 21 comprises a casing 23 prepared by joining a lower casing 24 to an upper casing 25 by a suitable joining means such as a screw. It is possible for the lower casing 24 and the upper casing 25 to be joined to each other by a suitable construction other than the screw engagement.

In the following description, a casing applied to an electronic equipment such as the portable computer 20 is called a casing 30 for an electronic equipment.

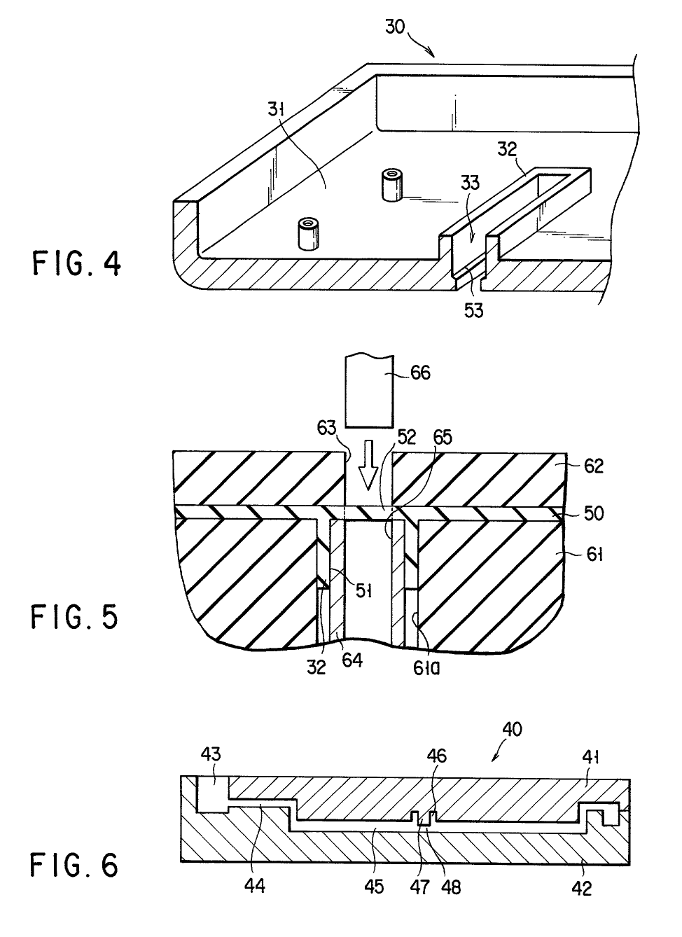

FIG. 4 shows the shape of the casing 30 of the present invention for an electronic equipment having a hole portion inside a rib structure. In the drawing, a rib 32 is formed to project from a casing body 31 of the casing 30 for an electronic equipment, and an insertion hole 33 is formed inside the rib 32.

The casing 30 of the particular construction for an electronic construction is formed as follows.

Specifically, in forming the casing 30 for an electronic equipment according to this embodiment of the present invention, a hole portion 46 extending upward from an inner cavity 45 of a molding apparatus consisting of an upper mold 41 and a lower mold 42 is formed in the upper mold 41 in a position corresponding to the rib 32, as shown in FIG. 6. Then, a melt is introduced from a sprue 43, which constitutes an inlet port of the melt of the molding apparatus 40. The melt is diffused within a runner 44, with the result that a substantially parallel flow of the melt is introduced into the cavity 45. Then, the melt 46 flows into the hole portion 46 so as to form a molded article 50 having the rib 32 projecting upward from the casing base body 31.

In the stage of the molded article 50, the bottom portion inside the rib 32 is closed by a bottom wall portion 52 to form a concave portion 51. The bottom wall portion 52 of the concave portion 51 is formed thinner than the other portion of the casing in view of the subsequent punching operation. To achieve the particular construction, a projecting portion 47 projecting downward from the upper mold 41 toward the lower mold 42 is formed inside the hole portion 46 of the cavity 45.

The projecting portion 47 is formed such that the lower end of the projection is not in contact with the lower mold 42 so as not to close the cavity 45. In other words, a clearance 48 is formed between the lower end of the projection and the lower mold 42 so as to permit the melt to flow through the clearance 48.

Therefore, if the melt is introduced into the mold 40 and, then, solidified, the concave portion 51 is formed inside the rib 32. As described previously, the bottom portion of the concave portion 51 is closed by the bottom portion 52 having a small thickness.

Incidentally, it is possible to reverse the relationship between the upper mold 41 and the lower mold 42 such that the hole portion 46 and the projecting portion 47 are formed in the lower mold 42.

The molded article 50 is formed after solidification of the melt introduced into the molding apparatus 40. After the molded article 50 is taken out of the molding apparatus 40, the molded article 50 is disposed on an upper surface of a die 61 constituting a punching apparatus. In this case, the molded article 50 is disposed on the die 61 such that the rib 32 faces downward as shown in FIG. 5 in view of the subsequent punching step. Therefore, the die 61 is provided with a guide hole 61a into which the rib 32 is inserted.

After the molded article 50 is disposed on the die 61, a stripper 62 is disposed on the molded article 50 from above the molded article 50. A guide hole 63 into which a punch 66 can be inserted is formed in that portion of the stripper 62 which corresponds to the rib 32 of the molded article 50. As a result, the punch 66 can be inserted smoothly so as to guide the punching process of the molded article 50.

After the molded article 50 is held between the die 61 and the stripper 62, a concave portion supporting die 64 is inserted into the concave portion 51 from the lower side toward which the rib 32 projects downward. Under this condition, an urging force is applied from below to the outer circumferential edge of the bottom portion 52 of the concave portion 51, which is to be punched, toward the stripper 62.

The concave portion supporting die 64 has an outer diameter conforming with the inner diameter of the concave portion 51 formed in the rib 32. Further, a punch insertion hole 65 is formed inside the concave portion supporting die 64 so as to permit the punch 66 to be inserted into the punch insertion hole 65. In other words, the punch insertion hole 65 is formed inside the concave portion supporting die 64 so as to make the concave portion supporting die 64 hollow.

After the outer circumferential edge of the bottom portion 52 is supported by the concave portion supporting die 64, the punch 66 is moved in a direction opposite to the inserting direction of the concave portion supporting die 64. In other words, the punch 66 is moved downward in the drawing, so as to punch and remove the bottom wall portion 52, making it possible to form the insertion hole 33 inside the rib 32.

It should be noted that, since the concave portion supporting die 64 is shaped to conform with the shape of the concave portion 51 of the rib 32, it is possible for the concave portion supporting die 64 to have various shapes. Also, the punch 66 is shaped to permit the outer surface to conform with the inner wall of the concave portion supporting die 64.

Further, in order to remove the residue after the punching operation, that portion of the concave portion supporting die 64 which is positioned below the punch insertion hole 65 is formed hollow. As a result, the punching residue can be discharged through the hollow portion to the lower portion.

If the bottom wall portion 52 is subjected to the punching treatment by the punch 66 after the bottom wall portion 52 is supported by the concave portion supporting die 64, the insertion hole 33 is formed in the concave portion 51 closed by the bottom wall portion 52. In this case, however, that portion of the bottom wall portion 52 which is supported by the concave portion supporting die 64 is not punched so as to form a remaining portion 53. In other words, the remaining portion 53 resides in the outer circumferential portion of the insertion hole 33 formed after the punching treatment of the bottom wall portion 52. However, since the inner diameter itself of the insertion hole 33 is determined in advance to conform with the size of the punch 66, formation of the remaining portion 53 does not produce a particular inconvenience.

Incidentally, the edge portion of the concave portion supporting die 64 and the edge portion of the punch 66 are arranged to substantially overlap with each other when the punch 66 is moved.

The projecting size of the remaining portion 53 is, for example, about 1 to 2 mm. In this connection, the thickness of the concave portion supporting die 64 is also set at about 1 to 2 mm.

Further, it is possible for the thickness of the remaining portion 53 (bottom wall portion 52) to be equal to or to be smaller than that of the other portion of the molded article 40 so as to facilitate the punching operation performed by the punch 66.

According to the casing 30 for an electronic equipment having the particular construction described above, the method of manufacturing the particular casing 30, and the punching apparatus used, the outer circumferential edge portion of the concave portion 51 formed in the molded article 50, which is disposed on the die 61, is supported by the concave portion supporting die 64 in preparation for the punching of the bottom wall portion 52 of the concave portion 51. Then, a punching treatment is applied to the bottom wall portion 52 from the side opposite to the side on which the concave portion supporting die 64 is arranged. At the same time, the edge portion of the bottom wall portion 52, which is to be punched, is firmly fixed by the concave portion supporting die 64. Further, the edge portion of the concave portion supporting die 64 and the edge portion of the punch 66 are positioned to substantially overlap with each other in the moving direction of the punch 66. Therefore, the broken surface in the punching step is formed neat so as to provide a satisfactory processed surface.

The particular construction of the present invention makes it possible to perform the punching treatment in a manner to make uniform the shape of the insertion hole 33 positioned inside the rib 32 in the width direction. It follows that the casing for an electronic equipment can be produced on a mass production basis even if the insertion hole 33 is formed by the punching treatment.

It is also possible to suppress the sagging caused by the processing in a lower portion in the punching direction. Further, since the insertion hole 33 can be formed by the punching process, it is possible to shorten the processing time for forming the insertion hole 33, leading to a low manufacturing cost.

What should also be noted is that, since the punching process is performed after the bottom wall portion 52 is firmly fixed by the concave portion supporting die 64, it is possible to prevent the bending occurring in the vicinity of the rib 32.

The embodiment of the present invention described above with reference to the accompanying drawings can be modified in various fashions. For example, in the embodiment described above, the molded article 50 is disposed on the upper surface of the die 61, and the concave portion supporting die 64 is inserted into the concave portion 51 formed in the molded article 50. However, it is not absolutely necessary to form the concave portion 51 as far as the molded article 50 can be fixed sufficiently by only the concave portion supporting die 64.

Also, in the embodiment described above, the insertion hole 33 is formed inside the rib 32. Needless to say, however, it is possible to apply the technical idea of the present invention to the case where the insertion hole 33 is formed in a region other than the rib 32, e.g., in a boss.

The present invention can be modified in various other fashions within the technical scope of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of manufacturing a casing for an electronic equipment, comprising the steps of:
preparing a molded article in which is formed a wall portion surrounded by a rib having a predetermined height;
allowing a supporting means formed to conform with said wall portion surrounded by said rib and having a hollow portion to be engaged with said wall portion so as to fix said molded article; and
punching that portion of the wall portion which is positioned inside said hollow portion by punching means from a side opposite to the side of said supporting means with said wall portion interposed therebetween so as to form a through-hole.

2. An electronic equipment comprising a casing having a hub of a predetermined height projecting from a wall portion and a hole formed inside said hub in a manner to extend through said wall portion, wherein a punching residue projecting inward in the circumferential direction of said hole is formed on the edge portion on the side of the wall portion of the hole.

3. A punching apparatus having supporting means, said punching apparatus being used in the case where a wall portion formed inside a rib of a molded article is punched for forming a hole positioned inside a rib of a casing for an electronic equipment, wherein said supporting means is shaped to conform with the concave portion inside said rib and has a hole portion through which punching means can be inserted inward.

4. An electronic equipment comprising a casing formed by a method comprising the steps of:
preparing a molded article in which is formed a wall portion surrounded by a rib having a predetermined height;
allowing a supporting means formed to conform with said wall portion surrounded by said rib and having a hollow portion to be engaged with said wall portion so as to fix said molded article; and
punching that portion of the wall portion which is positioned inside said hollow portion by punching means from a side opposite to the side of said supporting means with said wall portion interposed therebetween so as to form a through-hole.
